(19) United States
(12) Patent Application Publication
(10) Pub. No.: US 2003/0075907 A1
(43) Pub. Date: Apr. 24, 2003

(54) Method for restraining vehicle occupants

(76) Inventors: Karl-Heinz Baumann, Bondorf (DE); Lutz Quarg, Boblingen (DE); Alfred Schnabel, Althengstett (DE)

Correspondence Address: KENYON & KENYON, ONE BROADWAY, NEW YORK, NY, 10004, US

(21) Appl. No.: 10/217,092

(22) Filed: Aug. 12, 2002

(30) Foreign Application Priority Data
Aug. 11, 2001 (DE) 101 39 609.0

(51) Int. Cl. B60R 21/00; B60R 21/32

(52) U.S. Cl. 280/735; 180/271

(57) ABSTRACT

In a method for restraining vehicle occupants in which the loads on the vehicle occupants are reduced during the restraining process, a method for restraining vehicle occupants by dissipating kinetic energy provides that firstly a possible accident is sensed and then a force which acts in the direction of the impact is applied to the vehicle occupant at the latest at the time of the first contact between the vehicle and the obstacle, the force being set over the entire braking distance so that a constant acceleration acts on the vehicle occupant so that the dissipation of the kinetic energy occurs uniformly.

### CROSS-REFERENCE TO RELATED APPLICATIONS

The present application claims priority to Application No. 101 39 609.0, filed in the Federal Republic of Germany on Aug. 11, 2001, which is expressly incorporated herein in its entirety by reference thereto.

### FIELD OF THE INVENTION

The invention relates to a method for restraining occupants of a vehicle in the event of an impact against an obstacle by dissipating kinetic energy.

### BACKGROUND INFORMATION

Conventional restraining systems and the associated methods for restraining vehicle occupants function as follows: as soon as the vehicle experiences a deceleration due to an impact, the deceleration is sensed. The deceleration of the vehicle constitutes the trigger for the conventional restraining systems. This means that restraining systems are still not actuated at the time of the start of the impact. Accordingly, when the deceleration of the vehicle starts, the vehicle occupant maintains his original velocity which corresponds to the velocity of the vehicle before the impact. As a result, in the decelerated vehicle he moves forward in relation to the vehicle. The relative movement between the vehicle occupant and the vehicle is what makes the restraining systems come into use at all. The relative movement is accordingly an essential factor in the restraint of the vehicle occupant. For example, due to this relative movement, the vehicle occupant is pressed into an inflated air bag and/or dropped into a seat belt which is equipped with a seat belt pretensioner. The vehicle occupant who has up to this point been unbraked then begins to decelerate. Such a method is described, for example, in German Published Patent Application No. 44 11 184.

In these conventional methods for restraining occupants of a vehicle, the braking of a vehicle occupant takes place with a time delay with respect to the deceleration of the vehicle. Generally, at this time the vehicle already has zero velocity and has already “used up” a large part of its crush zone. Conventionally, the internal forward displacement of the vehicle occupant and the braking of the vehicle which is still taking place by means of the residual crush zone which is still present at the time when the restraining of the vehicle occupant starts are used to brake the vehicle occupant.

A disadvantage of these conventional methods for restraining vehicle occupants is that time passes after the start of an impact before a vehicle occupant is first braked. This is due, on the one hand, to the fact that time is required in order to reliably sense a relevant accident—i.e., in a manner which avoids mistriggering—and trigger the seat belt pretensioner and air bag. Due to the velocity of the vehicle occupant, in the first impact phase in which the vehicle occupant still moves forward without being braked, a large amount of usable braking distance is then wasted, without energy being dissipated, because the restraining systems are not yet engaged. The vehicle occupant can therefore only use up a part of the braking of the vehicle as a braking distance for dissipating his kinetic energy. This leads to a situation in which the greater part of the kinetic energy of the vehicle occupant must be dissipated at the end of the braking process over a very short time and a short braking distance, which can lead to large loads on the vehicle occupant.

Furthermore, it is described, for example, in German Published Patent Application No. 44 11 184 to actuate restraining systems even before an impact which may occur. A seat belt pretensioner is attracted to a predetermined force level in such a situation. When the impact occurs, the force level is increased. If the impact does not occur, the force level in the seat belt is reduced again to the original starting value. By this conventional method, the problems which occur in conjunction with the out-of-position problems are avoided. By tightening the belt to the first force level, the vehicle occupant is moved into a position which is optimum for the restraining systems. The definitive actuation of the restraining systems does not, however, occur here until an actual impact occurs, with the disadvantages described above.

It is an object of the present invention to provide a method for restraining vehicle occupants which reduces the loads on the vehicle occupant when a restraining process occurs.

### SUMMARY

The above and other beneficial objects of the present invention are achieved by providing a method as described herein.

According to one aspect of the present invention, firstly a possible accident is sensed and then a force is applied to the vehicle occupant at an early time, e.g., at the latest at the time of the first contact between the vehicle and an obstacle. This force acts in the direction of the impact. It is applied to the vehicle occupant so that a constant, e.g., uniform, force acts on the vehicle occupant over the entire braking distance. That is, an acceleration which is as constant as possible acts on the vehicle occupant over the entire braking distance. This force results in energy being dissipated uniformly over the entire braking distance. Wherever the term “braking distance” is used in conjunction with the invention, the reference is thus to the absolute distance of the vehicle occupant in the vehicle which is available for braking the vehicle occupant from the time of the first contact between the vehicle and the obstacle. This distance is composed of the dynamic overall deformation of the vehicle and the possible distance by which the vehicle occupant is moved forward in the passenger cell.

The force or acceleration acting on the vehicle occupant may be set as a function of the severity of the accident. This may be determined, for example, by a close-range radar system. The mass of the vehicle occupant and the position of the vehicle occupant may be included in the regulation of the force. If the latter is not the case, standard settings may be selected.

It is possible to use a precrash sensor system for the method according to the present invention. This impact sensor system may reliably detect an accident which is significant for a vehicle occupant, at the latest at the start of contact, e.g., even earlier.

The present invention may provide the advantage that the restraining of the vehicle occupant starts early, by a force applied to the vehicle occupant. As a result, the kinetic energy of the vehicle occupant may be reduced right from the time of the first contact, and the entire distance which is available may be used. That is, no time may pass before the reduction of the energy starts. This may result in more time being available for reduction.

According to the present invention, a constant force level is then applied to the vehicle occupant over this longer available time, leading to a uniform reduction in the kinetic energy. The combination of the features, early starting of the dissipation of energy and constant force level of the force acting on the vehicle occupant—or the constant deceleration of the vehicle occupant from the start of the crash onward—leads to the vehicle occupant being subjected to overall lower loads. This results from the fact that the energy level is already reduced promptly by the early start of the application of force, so that at the end, e.g., just before the vehicle comes to an absolute standstill, there is no need for a rapid dissipation of energy as described above.

In the present invention, the restraining of the vehicle occupant occurs independently of the deceleration of the vehicle. There is no need for a relative movement between the vehicle occupant and the vehicle for the restraining systems to become active.

The vehicle occupant may be moved in the direction of the impact by the application of force according to the present invention.

According to one example embodiment of the method according to the present invention for restraining vehicle occupants in the event of an impact, the force on the vehicle occupant is not applied locally but rather over an area. This may be performed, for example, by virtue of the fact that the area of contact between the vehicle occupant and the restraining system is configured so as to be correspondingly large. This load distribution or homogenization of the load may provide that the force applied to the vehicle occupant is applied distributed over the area, and is thus lower overall. This arrangement may avoid local force peaks.

The force may be applied by a plurality of restraining systems. As a result, the effective area for the transmission of force may be increased. The restraining systems may be actuated in succession and/or simultaneously depending on the peripheral conditions of the impact. The times at which the systems are actuated may thus be matched individually to each load situation.

According to another example embodiment of the method according to the present invention, the force is applied by different restraining systems in accordance with the direction of impact. For example, it is possible to actuate a side air bag and door bag in the event of a side impact, and a backrest and headrest in the event of a rear-end impact.

The present invention is explained in more detail below with reference to the Figures.

### BRIEF DESCRIPTION OF THE DRAWINGS

FIG. 1 illustrates the dissipation of energy of a vehicle occupant over the braking distance in a conventional system and in a system according to the present invention.

FIG. 2 illustrates the acceleration of a vehicle occupant over the braking distance in a conventional system and a system according to the present invention.

### DETAILED DESCRIPTION

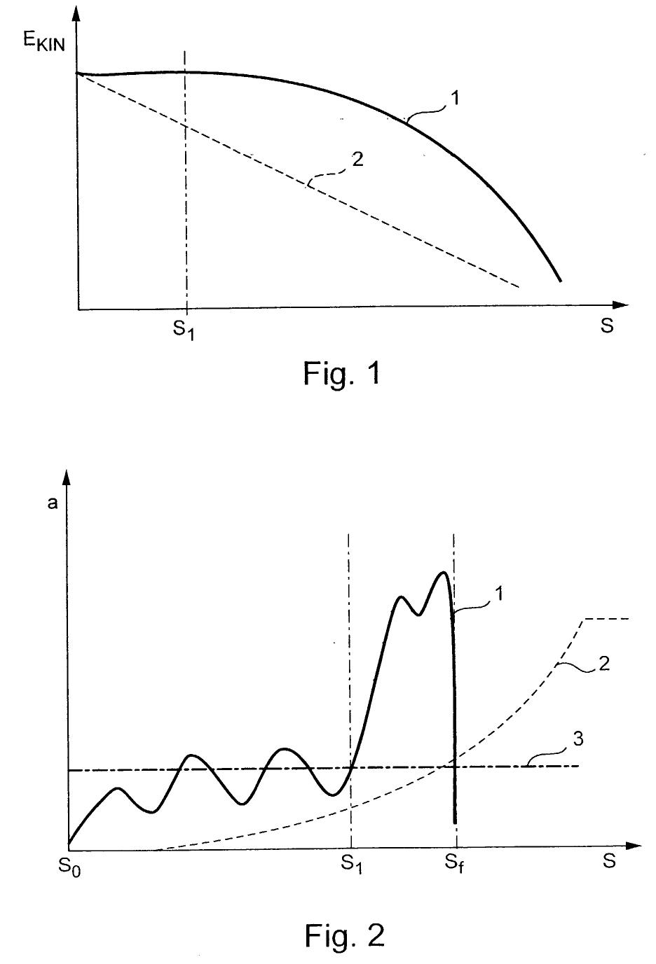

In FIG. 1, the relationship between the kinetic energy Eₖᵢₙ of the vehicle occupant over the braking distance s is illustrated. The braking distance is equal to 0 when the vehicle is first in contact with the obstacle against which it is impacting. The distance designated by braking distance includes the deformation zones which a vehicle exhibits—these may be, for example, approximately 0.6 m in the front region of the vehicle and approximately 0.3 m in the passenger cell. This is the distance which is available for braking a vehicle occupant from the time when the vehicle is first in contact with the obstacle up to it ultimately coming to a standstill. The vehicle occupant is still moved forward in an unbraked fashion at this time and therefore still has his original kinetic energy which is at a maximum with respect to the braking process.

The upper curve designated by 1 indicates the dissipation of energy of a conventional system. It should be noted that the first dissipation of energy starts at s₁, specifically to a very low degree. The dissipation then increases continuously until it is at a maximum just before the end of the available braking distance. At this time, the vehicle occupant is braked most strongly so that the greatest loads act on him at this time.

In contrast to this, with the method according to the present invention—lower curve indicated by 2—the energy is dissipated from the time of first contact, e.g., when the braking distance is still 0. It does not start after a delay. In addition, it is dissipated uniformly over the entire available distance. This is illustrated by the fact that the dissipation of energy occurs linearly. The dissipation has the same gradients at every point in the diagram. The curve indicated by 2 represents an ideal profile of the method according to the present invention.

For the vehicle occupant this means that he is continuously subjected to the same force or that a constant acceleration acts on him. The force is therefore precisely of the same size at the start of the restraining operation as at the end. The same applies to the acceleration. The situation in which the greater part of the energy has to be dissipated at the end of the braking distance, which leads to higher loads on the vehicle occupant, is thus avoided.

FIG. 2 illustrates the acceleration a of a vehicle occupant and of a vehicle over the braking distance s. The curve indicated by 1 represents the acceleration of the vehicle over the braking distance, which already ends earlier than the curve of the occupant, namely at a braking distance s_{f}. This is due to the fact that deformations in the passenger cell are not taken into account. The fluctuations occurring between s₀ and s₁ arise as a result of the deformation of a wide range of vehicle components or assemblies in the front region of the vehicle (for example, bumper, crash element, engine, etc.). The acceleration is at a maximum toward the end of the braking distance. The greater part of the energy is dissipated over a short distance.

The curve indicated by 2 illustrates the acceleration of a vehicle occupant with a conventional system. The braking distance is larger due to the additional deformation in the passenger cell. In accordance with the illustration in FIG. 1, the acceleration of the vehicle occupant does not start directly at the time of the first contact but rather somewhat later. This is due to the fact that the vehicle occupant firstly moves further forward at the same velocity. Restraining systems are actuated as a result of this velocity relative to the vehicle so that the acceleration of the vehicle occupant grows gradually. The acceleration is at a maximum towards the end of the braking distance.

In contrast to this, the curve which is indicated by 3 and which represents the acceleration of a vehicle occupant over the braking distance when the method according to the present invention is applied shows a constant acceleration over the entire braking distance. The acceleration begins directly at the start of the deceleration of the vehicle and remains constant over the entire braking distance. As indicated above, this results in the loads on the vehicle occupant being lower than in the conventional restraining method.

What is claimed is:

1. A method for restraining occupants of a vehicle in the event of an impact against an obstacle by dissipating kinetic energy of the vehicle occupant, comprising the steps of:
sensing a possible accident;
applying a force that acts in a direction of the impact to the vehicle occupant at the latest at a time of a first contact between the vehicle and the obstacle; and
setting the force over an entire braking distance so that a constant acceleration acts on the vehicle occupant to dissipate kinetic energy uniformly.

2. The method according to claim 1, further comprising the step of moving the vehicle occupant is in the direction of the impact in accordance with the force applying step.

3. The method according to claim 1, wherein the force applied in the applying step acts on the vehicle occupant over an area.

4. The method according to claim 1, wherein the force is applied to the vehicle occupant in the force applying step by a plurality of restraining systems that are actuated one of in succession and simultaneously.

5. The method according to claim 1, wherein the force is applied in the force applying step by different restraining systems in accordance with the direction of the impact.
